(19) United States
(12) Patent Application Publication
(10) Pub. No.: US 2026/0299929 A1
(43) Pub. Date: Oct. 1, 2026

(54) OVER-THE-AIR FIRMWARE UPDATES FOR MULTI-TIERED POOL AND SPA COMPONENTS BY A POOL AUTOMATION CONTROLLER

(71) Applicant: Zodiac Pool Systems LLC, Carlsbad, CA (US)

(72) Inventors: Minas Minassian, Carlsbad, CA (US); Mark J. Bauckman, San Marcos, CA (US); Sandra Morrison, Carlsbad, CA (US)

(73) Assignee: Zodiac Pool Systems LLC, Carlsbad, CA (US)

(21) Appl. No.: 19/570,529

(22) Filed: Mar. 18, 2026

Related U.S. Application Data
(60) Provisional application No. 63/778,019, filed on Mar. 26, 2025.

(51) Int. Cl. G06F 8/65

(52) U.S. Cl. CPC G06F 8/65

(57) ABSTRACT

Systems and methods for pushing over-the-air firmware updates to multi-tiered pool and spa components by a pool automation controller are disclosed. In an example method, a computing system receives a first indication of an available firmware update for a first piece of pool or spa equipment, wherein the first piece of pool or spa equipment is communicatively coupled with a controller device which is communicatively coupled with the pool automation controller. The computing system downloads a firmware image. The computing system outputs a first instruction to the controller device to update a firmware of the first piece of pool or spa equipment using the firmware image, in which the first instruction is configured to cause the controller device to output a second instruction to the first piece of pool or spa equipment to update its firmware using the firmware image.

### CROSS-REFERENCE TO RELATED APPLICATION

This application claims priority to provisional application U.S. Ser. No. 63/778,019 entitled “Over-The-Air Firmware Updates For Multi-Tiered Pool And Spa Components By A Pool Automation Controller” and filed on Mar. 26, 2025, the entire disclosure of which is incorporated herein by reference for any purpose.

### FIELD

This application relates to over-the-air (OTA) firmware updates and, more specifically, to OTA firmware updates for multi-tiered pool and spa components by a pool automation controller.

### BACKGROUND

A pool and spa system may include a pool automation controller (e.g., micro-controller and interface) that maintains a data connection with various pool equipment (e.g., pumps, heaters, chlorinators, speakers, lights, and other devices connectable to the network, etc.). The connection can be used for configuring and operating pool and spa equipment remotely.

Some pool and spa systems may include equipment that is configured or controlled using a multi-tier architecture. For example, a pool or spa system may include a number of lights. The lights can be controlled by the pool automation controller by issuing commands to a digital light controller. In turn, the digital light controller can issue commands to a number of digitally controlled lights. In this example, the pool automation controller is the tier one device, the digital light controller is the tier two device, and the lights are the tier three devices. Digitally operated devices in each tier may include firmware that can be updated from time to time.

### BRIEF DESCRIPTION OF THE DRAWINGS

FIG. 1 shows an example of a pool or system configured for OTA firmware updates for multi-tiered pool and spa components by a pool automation controller, according to some aspects of the present disclosure.

FIG. 2 shows an example sequence diagram for a protocol for providing OTA firmware updates for multi-tiered pool and spa components by a pool automation controller, according to some aspects of the present disclosure.

FIG. 3 shows a flowchart of an example method for providing OTA firmware updates for multi-tiered pool and spa components by a pool automation controller, according to some aspects of the present disclosure.

FIG. 4 shows a flowchart of an example method for providing OTA firmware updates for multi-tiered pool and spa components by a pool automation controller, according to some aspects of the present disclosure.

FIG. 5 shows a flowchart of another example method for providing OTA firmware updates for multi-tiered pool and spa components by a pool automation controller, according to some aspects of the present disclosure.

FIG. 6 shows a flowchart of an example method for providing OTA firmware updates for multi-tiered pool and spa components by a pool automation controller, according to some aspects of the present disclosure.

FIG. 7 shows a flowchart of an example method for providing OTA firmware updates for multi-tiered pool and spa components by a pool automation controller, according to some aspects of the present disclosure.

FIG. 8 shows an example computing device suitable for use in example systems or methods for OTA firmware updates for multi-tiered pool and spa components by a pool automation controller.

### DETAILED DESCRIPTION

### Overview

The subject matter of the present embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. References to “pools” and “swimming pools” herein may also refer to spas or other water containing vessels used for recreation or therapy.

As alluded to above, a pool or spa system may include equipment that is configured or controlled using a multi-tier architecture via wired or wireless network connections. Modern pool or spa equipment may be configured or controlled using a combination of hardware, software, and firmware. Manufacturers may issue software or firmware updates from time to time. Such software or firmware updates may involve modifications to control logic, communication protocols, safety thresholds, or equipment operating parameters. Updates may be distributed by the manufacturer via a cloud-based update server or published for manual download at web site or via a file transfer service.

Existing approaches require pool or spa operators to manually obtain update files and apply them to each piece of equipment individually, a process that is time-consuming, error-prone, and may result in inconsistent software or firmware versions across equipment within the same pool or spa system. For sufficiently complex pool or spa systems with large numbers of pieces of equipment, manual updating of software or firmware can quickly become an intractable demand. Manually applied updates may be installed out of sequence, causing dependency conflicts between interdependent equipment components that rely on synchronized protocol or data format versions. Additionally, existing approaches provide no centralized audit trail of update status across the system, leaving pool or spa operators without visibility into which equipment is running which version or whether any equipment has missed a critical safety or compliance-related update.

Systems and methods for “Over-The-Air” (OTA) firmware updates for multi-tiered pool and spa components by a pool automation controller according to this disclosure can be employed to address these challenges. In this context, OTA updates involve updates which can allow firmware to be distributed over a network or other suitable data connection without direct physical access to the device. In one example, the disclosed techniques can be used to push firmware updates to devices at any level of a multi-tiered hierarchy of connected devices.

A multi-tiered hierarchy of connected devices can refer generally to a networked architecture in which devices are organized into distinct levels or tiers based on distinctions such as function, capability, or proximity, with various communication and control relationships defined between levels. In one example, a “multi-tiered” configuration of pool or spa equipment may include a pool automation controller, a tier one device, having one or more connected tier two devices (e.g., saltwater chlorinator, digital light controller, etc.). In turn, each of the connected tier two devices may have 1 or more connected tier three devices (e.g., salt cells for the tier two saltwater chlorinator or digitally controlled lights for the tier two digital light controller). In this example, the tier one device acts as an overall controller or orchestrator. The tier one device delegates update tasks to tier two controller devices which have provenance over a number of related tier three devices. Other hierarchies, including more or less tiers, nested hierarchies, cross-functional hierarchies, and so may be similarly implemented according to this disclosure.

In an illustrative example update process, consider a simple pool or spa system with three tiers of equipment including a pool automation controller (tier one), a digital light controller (tier two), and a light (tier three). The pool automation controller is connected to the digital light controller via a wired Ethernet connection and the digital light controller communicates with the light via a wireless network connection. The light includes firmware with version 1.1. The pool automation controller receives, from a remote update server provided by the light manufacturer, an indication of an available version 1.2 firmware update for the light. The pool automation controller first downloads the firmware update image (e.g., a binary file) and then partitions firmware update image so that it can be reliably transmitted over the pool or spa network in verifiable partitions. The pool automation controller then outputs an instruction to the digital light controller to update the firmware of the light along with the firmware image partitions. The digital light controller in turn outputs an instruction to the light to update its firmware along with the firmware image partitions. Upon completing the update, the light responds to the digital light controller with information indicating that the firmware update was a success. The digital light controller then sends information indicating that the firmware update was a success to the pool automation controller. Alternatively, if the update failed, the message may indicate that the that firmware update has failed (e.g., due to a defective electrical power connection or network error) which can cause an automatic retry in some configurations.

It should be emphasized that this example including three tiers is non-limiting: some examples may include a fourth tier or a fifth tier, and so on. The techniques disclosed herein can be used for OTA updates for devices in any tier, including tier one. In general, any number and organization of tiers may be used according to various pool and spa applications. Likewise, OTA updates may be initiated at any level of the hierarchy of pool and spa control devices and equipment. For example, the firmware (or software) of tier one, 2, or 3 devices may be updated directly. Updates may be initiated at tier one or tier two, causing firmware updates to cascade to tier two and/or tier three devices. Other update topologies may be implemented in addition to these examples.

These illustrative examples are given to introduce the reader to the general subject matter discussed herein and the disclosure is not limited to these examples. The following sections describe various additional non-limiting examples of systems and methods for implementing OTA firmware updates for multi-tiered pool and spa components by a pool automation controller.

### Example System for OTA Firmware Updates for Multi-Tiered Pool and Spa Components by a Pool Automation Controller

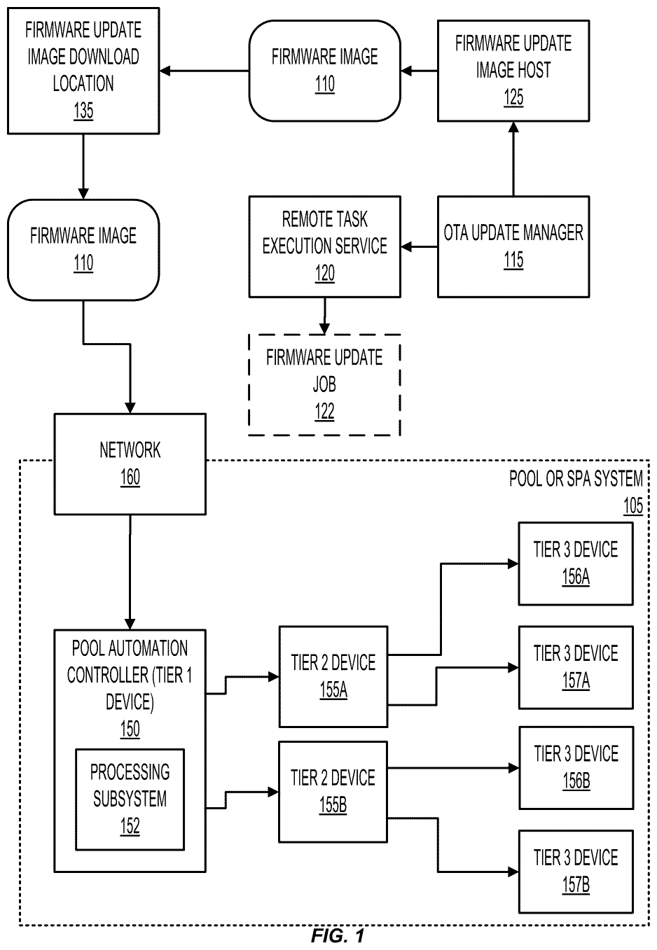

Turning first to FIG. 1, FIG. 1 shows an example of a pool or system 105 configured for OTA firmware updates for multi-tiered pool and spa components by a pool automation controller, according to some aspects of the present disclosure. The system 105 includes a pool automation controller 150. The pool automation controller 150 includes a processing subsystem 152 for executing functions implemented using instructions and other commands. FIG. 1 shows the processing subsystem 152 as a component of the pool automation controller 150. In some examples, the pool automation controller 150 may be connected to a standalone processing subsystem 152. In some examples, the processing subsystem may be a hardware or software component of a computing system such as an embedded computer, mobile device, or a combination of such components.

Some components of the pool automation controller 150 (e.g., a remotely hosted database) may be hosted in a cloud-computing environment accessible over a network 160 such as the Internet, a WiFi network, a Local Area Network (LAN), and so on. The processing subsystem 152 can be configured to execute program code in a memory using suitable software, hardware, firmware, or any combination thereof. Network 160 is shown schematically in FIG. 1 connecting the pool or spa system 105 to external components, but also represents network connections between and among the various devices depicted in the pool or spa system. Such connections may be implemented using any suitable wired or wireless communication medium, including Ethernet, RS-485 or RS-232, as well as wireless protocols such as Wi-Fi, Zigbee, Z-Wave, or Bluetooth.

FIG. 1 shows a schematic representation of a hierarchy of devices including three tiers. The pool automation controller 150 is a tier one device. Some examples may include additional tier one devices such as larger pool or spa systems with multiple networked control points. The pool automation controller 150 interfaces with tier two devices 155A, 155B. For example, the pool automation controller 150 may be communicatively coupled with the tier two devices 155A, 155B over network 160 using a suitable interface such as WiFi, Ethernet, a serial interface, and so on.

Although two tier two devices 155A, 155B are depicted interfacing with the example pool automation controller 150, any number of tier two devices may be in communication with the pool automation controller 150, subject to constraints on space or electrical power. The one or more tier two devices 155A, 155B or other tier two device may be co-located with the pool automation controller 150 (e.g., housed in the same electrical enclosure). In some examples, the pool automation controller 150 and the tier two devices 155A, 155B may be separated by a distance (e.g., 10 ft or 100 ft) and in communication as described above.

Each tier two device is in turn connected to one or more tier three devices. Tier two device 155A is connected to tier three devices 156A, 157A and tier two device 155B is connected to tier three devices 156B, 157B. Any number of tier three devices may be connected to the respective tier two devices 155A, 155B. The tier three devices 156A, 157A may be co-located with the tier two devices 155A, 155B. In most cases, the tier three devices 156A, 157A are located in or near a body of water associated with the pool or spa system 105. For instance, a tier three salt cell for a saltwater chlorinator may be located in a piping or filtering system and a tier three light can be located in or near the body of water.

Any suitable connection among the pool automation controller 150 and tier two devices 155A, 155B may be used for the exchange of instructions and data for OTA firmware updates. For example, they may be communicatively coupled using Ethernet, WiFi, RS-485, Bluetooth, Z-Wave, and so on. Likewise, any suitable connection between the tier two devices 155A, 155B and their respective tier three devices may be used, including Ethernet, WiFi, RS-485, Bluetooth, Z-Wave, and so on.

To update the firmware in tier three devices, an OTA update manager 115 first receives an indication of an available firmware update for a tier three device. This may be automatically detected or manually initiated by a user or maintainer of the pool or spa system 105. In some cases, the indication may be initiated by a manufacturer of the tier three device. The OTA update manager 115 may be, for example, an application running externally to the pool or spa system 105 (e.g., a web application in a cloud-hosting environment). Upon receipt of the indication, the OTA update manager 115 can output a command to download the firmware image 110 to a firmware image download location 135. The firmware image download location 135 may be a publicly accessible cloud-hosted storage location such as an AWS S3 bucket, Google Cloud Storage, Azure Blob Storage, and so on. The firmware image download location 135 may be allocated along with a publicly accessible URL that is returned to the OTA update manager 115.

The OTA update manager 115 can then output a command to a remote task execution service 120 to create a firmware update job 122 to update the firmware of the tier three devices. The remote task execution service 120 may be, for example, a cloud-hosted, job-based remote task execution service such as AWS IoT Core, Google Cloud IoT, Azure IoT Hub, or other services. The firmware update job 122, shown schematically in FIG. 1 using a dashed line, may include a set of instructions and metadata defining the firmware update process. The firmware update job 122 may be created and managed by the remote task execution service 120. Once created, the firmware update job 122 can trigger remote execution of commands on target devices such as pool automation controller 150 such as instructing the pool automation controller 150 to download the firmware update from the firmware image download location 135, verify the integrity of the firmware image 110, and so on.

For example, a pool equipment manufacturer may release a firmware update for a variable-speed pump (a tier three device). The OTA update manager 115, executing as a cloud web application, can detect the new firmware via an event-based messaging framework and download the firmware image 110 to the firmware image download location 135 such as an AWS S3 bucket. The OTA update manager 115 then issues a command to the remote task execution service 120 such as AWS IoT Core to create a firmware update job 122 targeting the pool automation controller 150 managing the pump. The remote task execution service 120 delivers the firmware update job 122 to the pool automation controller 150. The pool automation controller 150 downloads the firmware image 110 from the firmware image download location 135, verifies the image by computing a hash of the downloaded image, and compares it against a known accurate value such as a checksum in the firmware update job 122 payload, and then updates the pump according to the process of this disclosure.

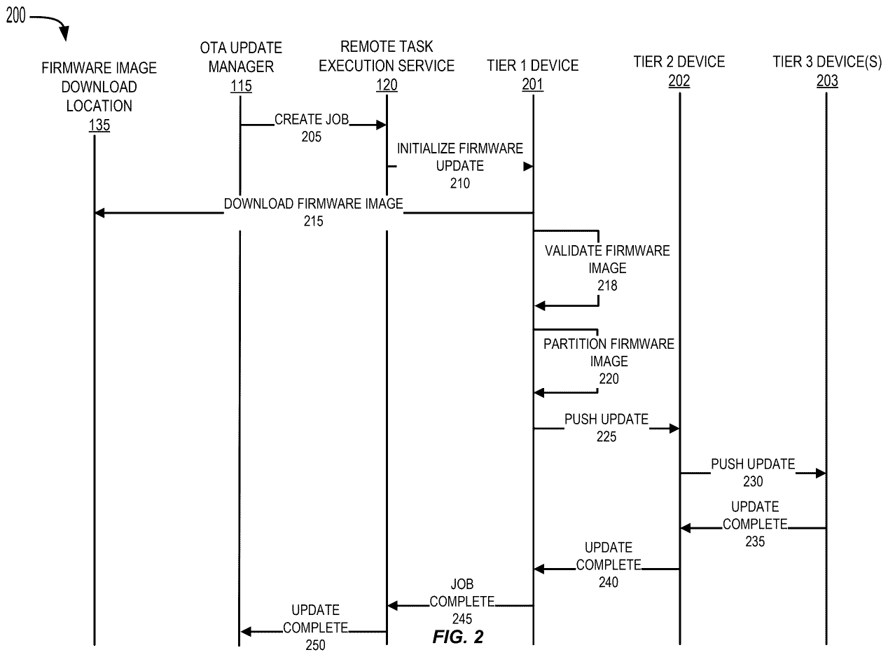

The following FIGS. 2-4 describe protocols and methods for performing OTA firmware updates for multi-tiered pool and spa components by the pool automation controller 150.

### Protocol for OTA Firmware Updates for Multi-Tiered Pool and Spa Components by a Pool Automation Controller

Referring now to FIG. 2, FIG. 2 shows an example sequence diagram 200 for a protocol for providing OTA firmware updates for multi-tiered pool and spa components by a pool automation controller, according to some aspects of the present disclosure. The description of the sequence diagram 200 in FIG. 2 will be made with reference to FIG. 1, however any suitable system according to this disclosure may be used. It should be appreciated that sequence diagram 200 provides a particular implementation of a protocol for providing OTA firmware updates for multi-tiered pool and spa components by a pool automation controller. Other sequences of operations may also be performed according to alternative examples. For example, alternative examples of the present disclosure may perform the steps outlined below in a different order. Moreover, the individual operations illustrated by sequence diagram 200 may include multiple sub-operations that may be performed in various sequences as appropriate to the individual operation. Furthermore, additional operations may be added or removed depending on the particular applications. Further, the operations described in sequence diagram 200 may be performed by different devices. For example, the description is given from the perspective of various components of the pool and spa system 105 as well as some external components (e.g., the remote task execution service 120) but other configurations are possible. One of ordinary skill in the art would recognize many variations, modifications, and alternatives.

The OTA update manager 115 initiates the protocol in response to a trigger such as detection of the update or a manual trigger. At 205, the OTA update manager 115 outputs a command to cause the remote task execution service 120 to create a job (e.g., firmware update job 122) that includes instructions to carry out the remaining steps of sequence diagram 200. At 210, the firmware update job 122 causes the remote task execution service 120 to output a command to a tier one device 201 (e.g., pool automation controller 150) to initialize the firmware update, along with additional instructions (not shown). The command may include information about which tier two device the update is intended for. In some examples, the command may also include information about which tier three devices the firmware update is intended for, although this may also be determined by the tier two device, as described below. At 215, the tier one device 201 downloads the firmware image from the firmware image download location 135 (e.g., an S3 bucket at a public URL). At 218, the firmware image is validated. For example, a checksum or cryptographic hash can be computed based on the firmware image and compared with a value obtained via a secure channel (e.g., a cryptographically secured website, message, or email) to ensure the integrity of the downloaded firmware image.

At 220, the tier one device 201 partitions the firmware image. At 225, the tier one device 201 pushes the update to a tier two device 202 (e.g., a saltwater chlorinator controller). This operation may involve transmitting the partitioned firmware image over a serial interface such as RS-485, using a chunked transfer protocol. The tier one device 201 may also send information about which tier three devices 203 the firmware update is intended for as well as instructions and/or commands for updating the tier three devices 203. However, in some examples, the tier two device 202 can determine which tier three devices 203 the firmware update is intended for. At 230, the tier two device 202 pushes the update to one or more tier three devices 203 (e.g., digitally controlled salt cells configured and controlled by a saltwater chlorinator controller), again using a serial interface. While serial interfaces are used in this example, other interfaces may be used as well such as WiFi, Bluetooth, Ethernet, etc. The tier two device 202 may also send instructions and/or commands for applying the firmware update to the tier three devices 203.

After applying the update, the tier three devices 203 send an update complete (or failed update) message back to the tier two device 202 at 235. In some examples, the status of the update operation (complete, failed, etc.) may be signified by each tier three device sending the current firmware version to the tier two device 202, in which the new firmware version corresponding to the firmware image indicates a successful firmware update. The tier two device 202 likewise sends an update complete (or failed update(s)) message back to the tier one device 201 at 240. At 245, the tier one device 201 notifies the remote task execution service 120 that the job is complete. At 250, the remote task execution service 120 notifies the OTA update manager 115 that the firmware update is complete.

### Methods for OTA Firmware Updates for Multi-Tiered Pool and Spa Components by a Pool Automation Controller

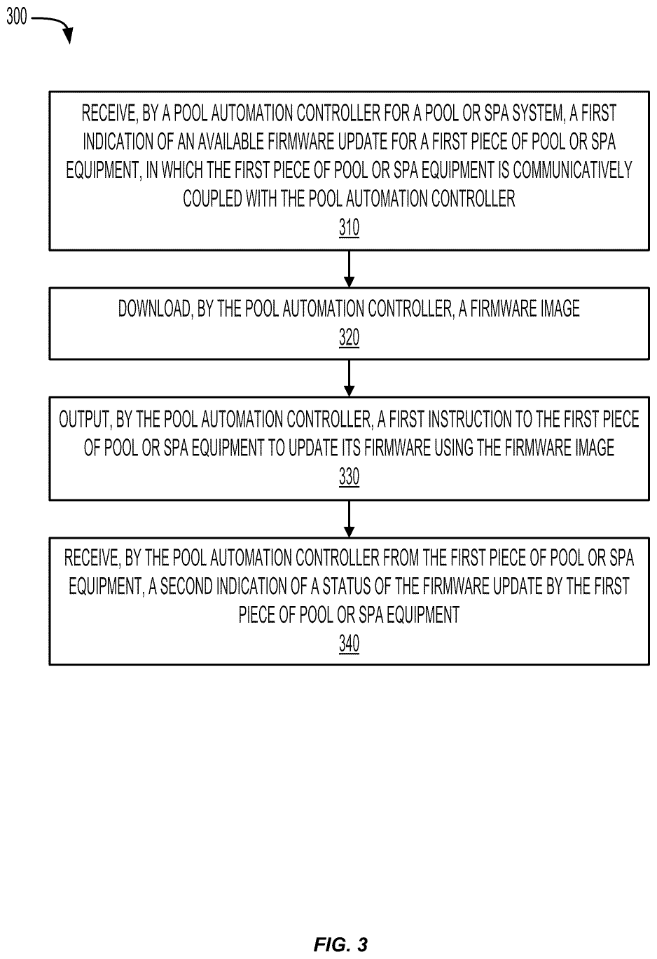

Referring now to FIG. 3, FIG. 3 shows a flowchart of an example method 300 for providing OTA firmware updates for multi-tiered pool and spa components by a pool automation controller, according to some aspects of the present disclosure. The description of the method 300 in FIG. 3 will be made with reference to FIG. 1, however any suitable system according to this disclosure may be used. It should be appreciated that method 300 provides a particular method for providing OTA firmware updates for multi-tiered pool and spa components by a pool automation controller. Other sequences of operations may also be performed according to alternative examples. For example, alternative examples of the present disclosure may perform the steps outlined below in a different order. Moreover, the individual operations illustrated by method 300 may include multiple sub-operations that may be performed in various sequences as appropriate to the individual operation. Furthermore, additional operations may be added or removed depending on the particular applications. One of ordinary skill in the art would recognize many variations, modifications, and alternatives.

The method 300 may include block 310. At block 310, a computing system, such as pool automation controller 150, receives a first indication of an available firmware update for a first piece of pool or spa equipment, in which the first piece of pool or spa equipment is communicatively coupled with the pool automation controller. The computing system may include a user interface that a maintainer or operator of the pool or spa system 105 can use to initiate or authorize a firmware update. In some examples, the computing system may monitor a network location (e.g., polling a firmware update web service) for available updates and initiate the update process when an available update is detected. In some examples, the firmware update web service may send a notification that a firmware update is available. In some examples, the indication may be caused by a firmware update job 122 created by a remote task execution service 120 and initiated by an OTA update manager 115.

In some examples, the firmware update image may be sourced from a local or peer-to-peer communication channel rather than a remote network location. For example, a mobile user device executing pool automation client software may establish a network connection with the pool automation controller 150 using Wi-Fi, a direct wired connection, or a Bluetooth Low Energy (BLE) connection. The user device can transmit a firmware update image over the connection. The user device can retrieve the firmware update image from a local memory or removable storage medium and stream the firmware update image as a binary stream over the connection. The client software may be configured to check for and download updates automatically, periodically, or in response to manual requests from the pool or spa operator.

In this example, the OTA update is a two-tiered process in which the computing system updates the first piece of pool or spa equipment directly. In some examples, the first piece of pool or spa equipment is further communicatively coupled with a controller device which is communicatively coupled with the pool automation controller. The controller device may be, for example, a digital light controller or a saltwater chlorinator controller. The first piece of pool or spa equipment may be a digitally controlled light or a digitally controlled salt cell, respectively. Other examples of pool and spa equipment controlled by a digital controller device may include variable-speed pumps, automated valves, heaters, spa blowers, automated pool covers, water level sensors, filtration systems, and so on.

At block 320, the computing system downloads the firmware image. For example, the first indication may include information including a URL for a firmware image download location 135 and instructions to download the firmware image 110. The computing system can download the firmware image 110 using a suitable protocol such as FTP, HTTP, HTTPS, sFTP, SCP, and so on. Cryptographically secure protocols such as HTTPS, sFTP, or SCP may be preferable to ensure the integrity of the firmware image, to protect proprietary information reflected in the firmware image, and to protect the privacy of the pool or spa system.

In some examples, the computing system can validate the downloaded firmware image. For example, a checksum or cryptographic hash can be computed based on the firmware image and compared with a value obtained via a secure channel (e.g., a cryptographically secured website, message, or email) to ensure the integrity of the downloaded firmware image. Examples of has algorithms include SHA-256 or MD5. In some examples, the firmware image can be digitally signed by the device manufacturer using a private cryptographic key and validated using a trusted public cryptographic key of the device manufacturer.

In some examples, the computing system can partition the firmware image. For example, the computing system can partition the firmware image 110 by dividing the firmware image file into smaller, fixed-size chunks or variable-length segments based on certain constraints such as memory limits, transmission protocol requirements, or target device buffer size. The computing system, upon receipt of the firmware image, can use metadata embedded in the firmware image, configuration files or other configuration data stored locally or remotely, or use system policies to identify the constraints. Information about partitioning the firmware image may also be included with the first indication as received via the update job 122 created by the remote task execution service 120.

For instance, the firmware image may include a manifest file specifying a partitioning scheme, such as fixed-size chunks or variable-length segments. In another example, the computing system can use locally stored configuration information about the controller device or the first piece of pool or spa equipment to determine parameters such as maximum buffer size, supported transmission protocols, or memory constraints for the target devices. The partitioning process can be implemented using file system operations, in-memory buffers, stream-based processing, or other suitable data processing approach. When partitioning is used, instructions to pool or spa equipment or intermediate controller device to update firmware may involve streaming each partition of the firmware image sequentially to the first piece of pool or spa equipment.

At block 330, the computing system outputting, by the pool automation controller, a first instruction to the first piece of pool or spa equipment to update its firmware using the firmware image. For example, the first instruction may include instructions to validate the firmware image, in whole or in part, and to assemble the firmware image if it is partitioned.

In some multi-tiered examples, the first instruction may be sent via the controller device and the first instruction may be configured to cause the controller device to output a second instruction to the first piece of pool or spa equipment to update its firmware using the firmware image. For example, the first instruction may include the second instruction as a nested instruction, along with further instructions to send the second instruction to the first piece of pool or spa equipment. The second instruction may include instructions to validate the firmware image, in whole or in part, and to assemble the firmware image if partitioning it in use. In some examples, the first instruction may be configured to cause the controller device to output second instructions to a number of pieces of pool or spa equipment. In these cases, the first instruction may include information specifying the particular pieces of pool or spa equipment to update.

The first (or second) instruction may include instructions to apply the firmware update to the first piece of pool or spa equipment. For example, the first piece of pool or spa equipment may be instructed to apply the firmware update by first verifying the integrity of the received firmware image using a checksum or cryptographic hash. The first piece of pool or spa equipment may then be instructed to write the updated firmware image to a designated memory region, such as flash storage. This can involve either overwriting the existing firmware version or by writing the updated firmware to a second designated memory region, to enable a fallback operation to the previous version in case of failure.

In some examples, the first (or second) instructions may further include instructions to update a bootloader of the first piece of pool or spa equipment (e.g., update the memory location of the firmware used at startup) and then restart the first piece of pool or spa equipment. The first (or second) instructions may further include instructions to notify the controller device of the result of the firmware update (e.g., successful, failed, pending, etc.).

The instructions according this example may be based on the same or different script or binary execution technologies. For example, the first instruction may include scripts or binary machine code that is executable by the controller device, but not the first piece of pool or spa equipment. Likewise, the second instruction may include scripts or binary machine code that is executable by the first piece of pool or spa equipment, but not the controller device.

In this example, one piece of pool or spa equipment is updated, but the first instruction may be further configured to cause updates for the firmware of numerous devices with one instruction. For example, in a multi-tiered setup, the first instruction may be further configured to cause the controller device to update the firmware all connected tier three devices associated with the controller device.

At block 340, the computing system receives, from the first piece of pool or spa equipment, a second indication of a status of the firmware update by the first piece of pool or spa equipment. Or, in the multi-tiered example, the second indication may be received from the controller device responsive to receiving an indication of the status of the firmware update from the first piece of pool or spa equipment. For example, the controller device can wait a configurable period of time for messages from the first piece of pool or spa equipment. Upon receipt of a status message from the first piece of pool or spa equipment, the controller device can output the second indication to the computing system. In some examples, the controller device can be configured to retry the update in the event that the first piece of pool or spa equipment reports a failed update attempt or times out. In examples in which numerous devices are updated at the same time, the indications may be received separately for each updated device.

The operations described in method 300 may be performed by different devices. For example, the description is given from the perspective of the pool automation controller 150 (a tier one device) but other configurations are possible. For example, some or all of operations described in method 300 could be performed by tier two devices, such as the controller device of method 300. For example, the controller device can receive an indication of an available firmware update for a first piece of pool or spa equipment directly. The controller device can download the firmware image and partition the firmware image, as described above with respect to blocks 320 and 330. The controller device can output an instruction to the first piece of pool or spa equipment to update its firmware along with the partitioned firmware image, as described in block 340. The controller device can receive, from the first piece of pool or spa equipment, an indication that the firmware update is complete. In this example, the tier two device can operate independently of direction or instruction from the tier one device. Likewise, in some examples, the tier one device can update the tier three devices directly, bypassing the tier two device.

Method 300 illustrates an OTA firmware update process for a pool or spa system such as pool or spa system 105 of FIG. 1. In some examples, the process illustrated in method 300 can be used to orchestrate firmware updates across many different pool and spa systems. For example, a tier two and three device manufacturer, such as the manufacturer of a saltwater chlorinator controller may develop a firmware update for the tier three salt cells. These devices may be installed in a large variety of pool or spa systems, geographically dispersed throughout the world. Each pool or spa system is reachable over the public Internet. In this case, the first indication may be one of multiple first indications pushed out by the device manufacturer to registered owners or operators of the device. In this respect, the method 300 can be used at the scale of a single pool or spa system or at a large scale including any pool or spa system located throughout the world that is reachable via a public network and appropriately configured, as described herein.

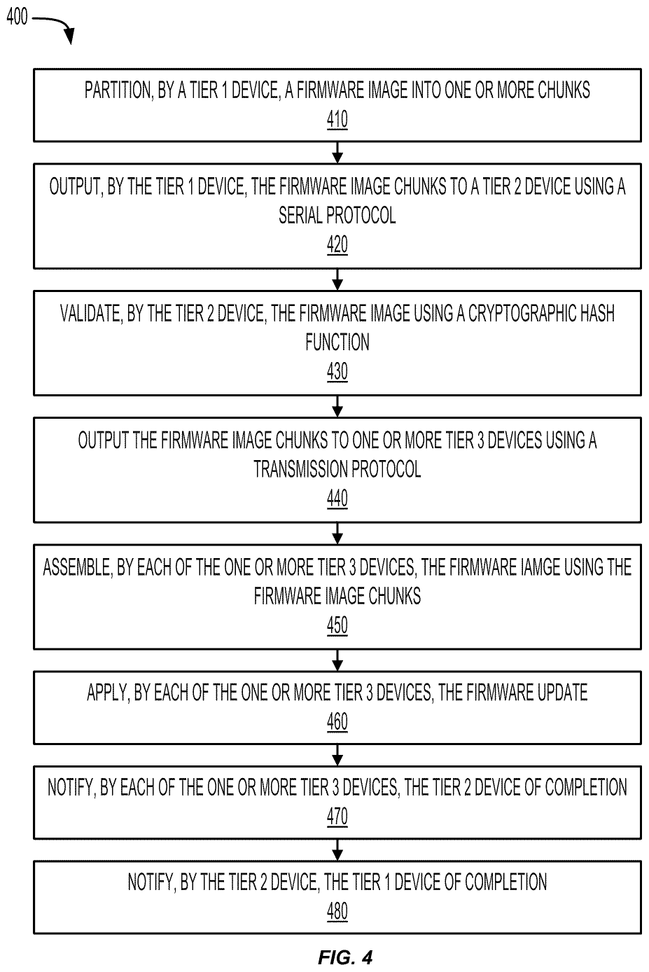

Referring now to FIG. 4, FIG. 4 shows a flowchart of an example method 400 for providing OTA firmware updates for multi-tiered pool and spa components by a pool automation controller, according to some aspects of the present disclosure. The description of the method 400 in FIG. 4 will be made with reference to FIG. 1, however any suitable system according to this disclosure may be used. It should be appreciated that method 400 provides a particular method for providing OTA firmware updates for multi-tiered pool and spa components by a pool automation controller. Other sequences of operations may also be performed according to alternative examples. For example, alternative examples of the present disclosure may perform the steps outlined below in a different order. Moreover, the individual operations illustrated by method 400 may include multiple sub-operations that may be performed in various sequences as appropriate to the individual operation. Furthermore, additional operations may be added or removed depending on the particular applications. Further, the operations described in method 400 may be performed by different devices. For example, the description is given from the perspective of various components of the pool and spa system 105 but other configurations are possible. One of ordinary skill in the art would recognize many variations, modifications, and alternatives.

The method 400 may include block 410. At block 410, a tier one device such as a pool automation controller 150, partitions a firmware image into one or more chunks. The firmware image may be, for example, an archive or compressed file including a binary payload, a cryptographic hash, a version identifier, and a digital signature. The tier one device may divide the firmware image into fixed-size chunks (e.g., 4 KB or 16 KB) or variable-length segments based on memory constraints and transmission protocol requirements. The partitions may include metadata such as sequence numbers or checksums for reassembly and verification.

At block 420, the tier one device outputs the firmware image chunks to a tier two device using a serial protocol. For example, the chunks can be transmitted serially over the RS-485 interface. The chunks may be included in a predefined packet structure that includes information such as a device address or identifier, a sequence number, and error-checking information.

At block 430, the tier two device validates the firmware image using a cryptographic hash function. For example, the tier two device can compute a hash value for the reassembled firmware image and compare it against an expected hash value provided in the metadata to ensure integrity and authenticity.

At block 440, the tier two device outputs the firmware image chunks to one or more tier three devices using a transmission protocol. For example, the transmission protocol may be a networking protocol. In this example, the chunks may be sent sequentially or concurrently, according to the particular networking protocol. For instance, the chunks may be sent sequentially using TCP to ensure ordered delivery or concurrently over multiple UDP streams to maximize throughput with lower latency. In another example, the transmission protocol may be a serial protocol. In this case, the chunks may be transmitted serially over an RS-485 interface as described in block 420 above. Other transmission protocols may be used such as Universal Serial Bus (“USB”) or Peripheral Component Interconnect (“PCI”).

At block 450, each of the one or more tier three devices assembles the firmware image using the firmware image chunks. For example, each device can reassemble the chunks into the complete firmware image by arranging the chunks in sequence and verifying their integrity using the provided metadata.

At block 460, each of the one or more tier three devices applies the firmware update. For example, each device can write the reassembled firmware image into its memory and execute the locally stored procedures to activate the new firmware. Each device may need to update pointers to the firmware (e.g., processor registers or EPROM) and/or restart.

At block 470, each of the one or more tier three devices notifies the tier two device of completion. The notification may include a success, failure, pending or other status. The notification may be output using the RS-485 protocol as described above with respect to block 440.

At block 480, the tier two device notifies the tier one device of completion. For example, the tier two device can send information about the update status of each of the one or more tier three devices. In some examples, the tier two device may retry one or more updates in the event of a failed or timed out status.

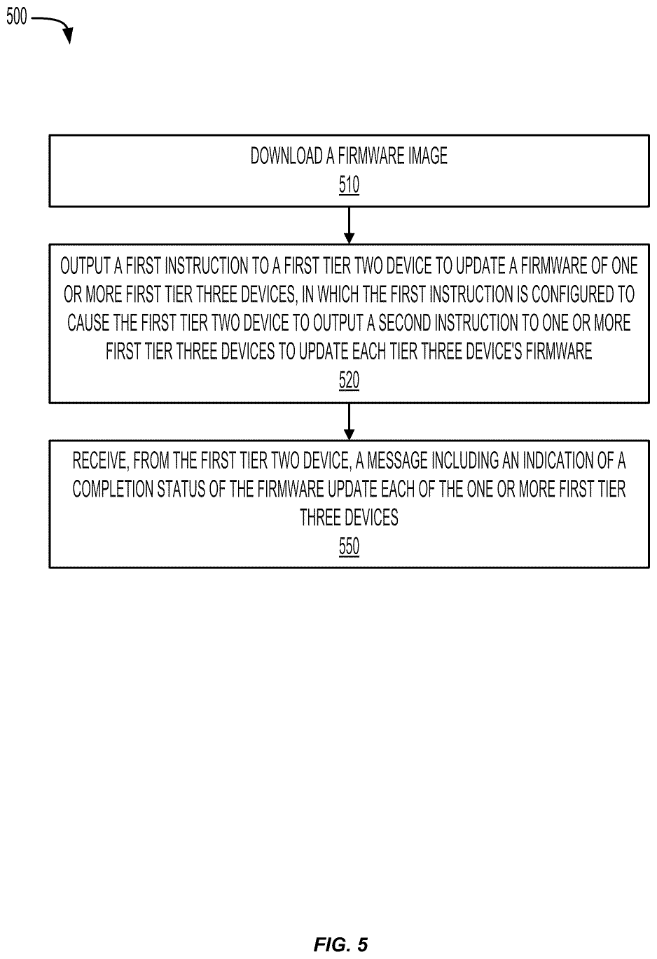

Referring now to FIG. 5, FIG. 5 shows a flowchart of another example method 500 for providing OTA firmware updates for multi-tiered pool and spa components by a pool automation controller, according to some aspects of the present disclosure. The description of the method 500 in FIG. 5 will be made with reference to FIG. 1, however any suitable system according to this disclosure may be used. It should be appreciated that method 500 provides a particular method for providing OTA firmware updates for multi-tiered pool and spa components by a pool automation controller. Other sequences of operations may also be performed according to alternative examples. For example, alternative examples of the present disclosure may perform the steps outlined below in a different order. Moreover, the individual operations illustrated by method 500 may include multiple sub-operations that may be performed in various sequences as appropriate to the individual operation. Furthermore, additional operations may be added or removed depending on the particular applications. One of ordinary skill in the art would recognize many variations, modifications, and alternatives.

The method 500 may be performed by a pool or spa system that includes a multi-tiered hierarchy of pool or spa equipment including a tier one device; one or more tier two devices; and one or more tier three devices, each of which is controlled by a respective tier two device. The tier one device, such as the pool automation controller 150 of FIG. 1, may include non-transitory computer-readable media and processors for executing the steps of this method 500. The method 500 may include block 510.

At block 510, a computing system, such as the pool automation controller 150 of FIG. 1, downloads a firmware image. This block may be performed by the computing system substantially as described with respect to block 310 of FIG. 3. For example, the firmware image may be an update for the existing firmware installed on various lights, which are tier three devices controlled by a respective lighting controller, a tier two device. In another example, the firmware image may be an update for the existing firmware installed on the salt cells (tier three devices) controlled by a saltwater chlorinator (a tier two device).

The method 500 may include block 520. At block 520, the computing system outputs a first instruction to a first tier two device to update a firmware of one or more first tier three devices, in which the first instruction is configured to cause the first tier two device to output a second instruction to one or more first tier three devices to update each tier three device's firmware. For example, the first instruction may include a command for the tier two device to execute that includes a target firmware version and a distribution policy. For instance, the first instruction may be a JSON-structured command object. The tier two device, upon receipt, can construct and dispatch second instructions including the target version along with any device-specific parameters required to execute the update on each tier three device.

The method 500 may include block 530. At block 530, the computing system receives, from the first tier two device, a message including an indication of a completion status of the firmware update each of the one or more first tier three devices. The message may indicate statuses such as success, failure, pending, or other status, and include additional information such as a per-device error code, a firmware version string confirming the installed image, and a timestamp marking completion or failure of each tier three devices'update attempt, and so on.

In some examples, the message including the indication of the completion status of the firmware update each of the one or more first tier three devices may include as least one indication of a failed firmware update. In that case, the computing system can retry outputting the first instruction (or a new instruction) to the first tier two device to update the firmware of the one or more first tier three devices to cause the firmware update to retry. Retries may be reattempted up to a configurable number of times. Information about the nature of the failures, such as error messages or error codes, may be provided to the computing system for review by pool or spa operators.

The pool or spa system according to this method is not limited to a three-tier hierarchy. For example, the pool or spa system may further include one or more tier four devices, each of which is coupled with a respective tier three device. The tier four devices may be, for example, subcomponents of the tier three devices. For instance, a four tier system may include a pool automation controller (tier one), several lighting controllers (tier two), each lighting controller controlling several light fixtures (tier three), and each light fixture housing several lights (tier four). Each device at each level of the hierarchy may be controlled using digital commands and may thus include independent firmware or software that can be updated. In this case, the first instruction may be further configured to cause each of the one or more first tier three devices to update each tier four device's firmware, similarly to how the tier three devices are updated according to this method 500.

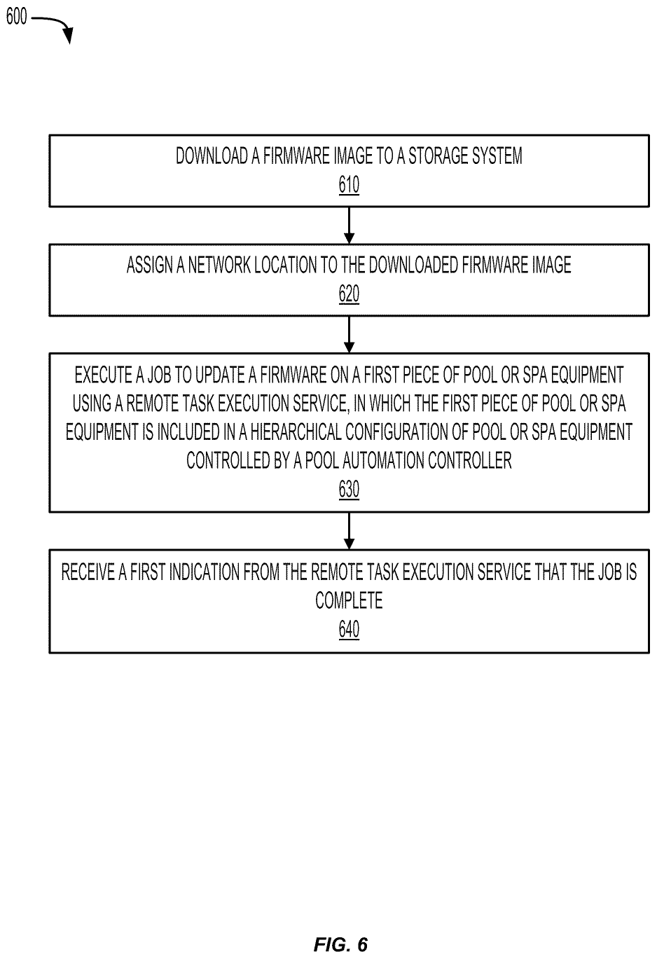

Referring now to FIG. 6, FIG. 6 shows a flowchart of an example method 600 for providing OTA firmware updates for multi-tiered pool and spa components by a pool automation controller, according to some aspects of the present disclosure. The description of the method 600 in FIG. 6 will be made with reference to FIG. 1, however any suitable system according to this disclosure may be used. It should be appreciated that method 600 provides a particular method for providing OTA firmware updates for multi-tiered pool and spa components by a pool automation controller. Other sequences of operations may also be performed according to alternative examples. For example, alternative examples of the present disclosure may perform the steps outlined below in a different order. Moreover, the individual operations illustrated by method 600 may include multiple sub-operations that may be performed in various sequences as appropriate to the individual operation. Furthermore, additional operations may be added or removed depending on the particular applications. Further, the operations described in method 600 may be performed by different devices. For example, the description is given from the perspective of various components of the system 100 of FIG. 1 or sequence diagram 200 of FIG. 2 including the OTA update manager 115, the remote task execution service 120, or the pool automation controller 150 but other configurations are possible. One of ordinary skill in the art would recognize many variations, modifications, and alternatives.

The method 600 may include block 610. At block 610, a computing system downloads a firmware image to a storage system. For example, a firmware update process may be initiated as described with respect to FIG. 2. The computing system may download the firmware image from, for example, a manufacturer's website or API.

The method 600 may include block 620. At block 620, the computing system assigns a network location to the downloaded firmware image. For example, the computing system may create a new S3 bucket or equivalent object storage container and receipt a presigned URL from the associated storage provider. The assigned network location may be provided to downstream devices to download the firmware image upon execution of the job created in block 630 below.

The method 600 may include block 630. At block 630, the computing system executes a job to update a firmware on a first piece of pool or spa equipment using a remote task execution service, in which the first piece of pool or spa equipment is included in a hierarchical configuration of pool or spa equipment controlled by a pool automation controller. For example, the computing system may invoke an API call to the remote task execution service (e.g., AWS IoT Jobs or Azure IoT Hub API) including a specification of the firmware image URL assigned at block 620, a target device identifier corresponding to the first piece of pool or spa equipment (e.g., a variable-speed pump controller, light, or salt cell), and other configurations such as execution timeouts and callback URLs to report failures to. Execution of the job by the remote task execution service may cause the pool automation controller to download the firmware image from the network location and update the firmware of the first piece of pool or spa equipment, as described with respect to FIGS. 3 and 5.

The method 600 may include block 640. At block 640, the computing system receives a first indication from the remote task execution service that the job is complete. For example, upon successful installation of the firmware on a light, information about the successful install may be passed up the hierarchy of devices, through the lighting controller, to the pool automation controller, and then to the remote task execution service. The remote task execution service may return, to the OTA update manager, information about the job completion such as a JSON object including metadata about the firmware update (e.g., status, timestamp of completion, etc.). In some examples, the computing system can update a device registry to reflect the new firmware version installed on the first piece of pool or spa equipment.

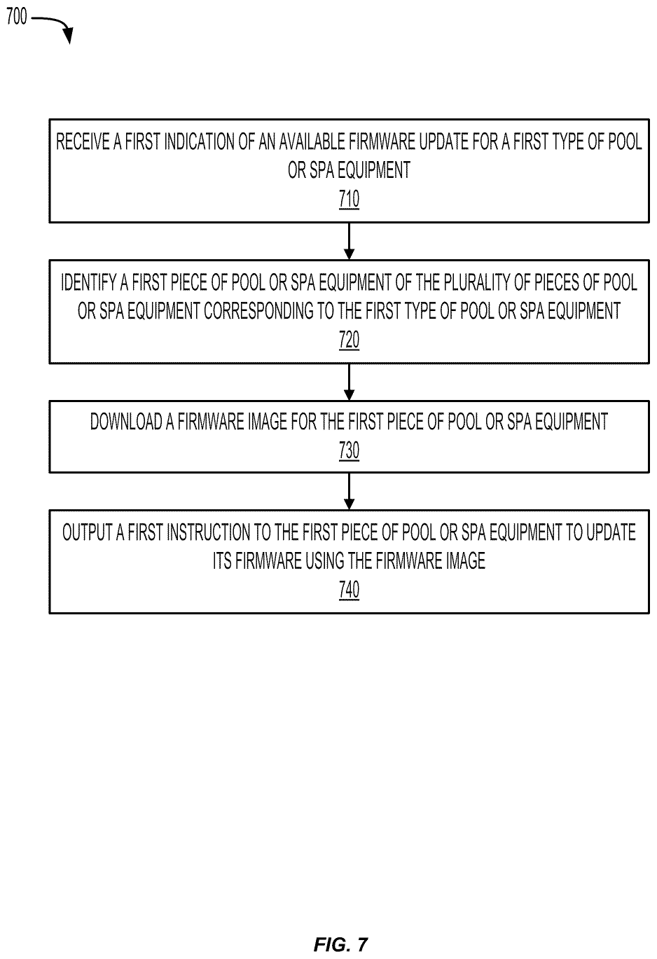

Referring now to FIG. 7, FIG. 7 shows a flowchart of an example method 700 for providing OTA firmware updates for multi-tiered pool and spa components by a pool automation controller, according to some aspects of the present disclosure. The description of the method 700 in FIG. 7 will be made with reference to FIG. 1, however any suitable system according to this disclosure may be used. It should be appreciated that method 700 provides a particular method for providing OTA firmware updates for multi-tiered pool and spa components by a pool automation controller. Other sequences of operations may also be performed according to alternative examples. For example, alternative examples of the present disclosure may perform the steps outlined below in a different order. Moreover, the individual operations illustrated by method 700 may include multiple sub-operations that may be performed in various sequences as appropriate to the individual operation. Furthermore, additional operations may be added or removed depending on the particular applications. Further, the operations described in method 700 may be performed by different devices.

The method 700 is described from the perspective of the pool automation controller 150 of FIG. 1. The pool automation controller 150 may be included in a pool or spa system that includes a multi-tiered hierarchy of pool or spa equipment including a tier one device; one or more tier two devices; and one or more tier three devices, each of which is controlled by a respective tier two device. The tier one device, such as the pool automation controller 150 of FIG. 1, may include non-transitory computer-readable media and processors for executing the steps of this method 700.

The method 700 may include block 710. At block 710, a computing system receives a first indication of an available firmware update for a first type of pool or spa equipment. This block can proceed substantially as described with respect to block 310 of FIG. 3. In this case, however, the indication corresponds to a type of pool or spa equipment, rather than to a specific piece of pool or spa equipment. Steps of this method involve identifying the piece or pieces of pool or spa equipment to update by querying the various devices included in the hierarchy of tier two and tier three devices to identify devices to update. The type may include categories of equipment, devices with certain versions or version ranges of firmware presently installed, ranges of serial numbers or categories of devices, devices with particular dates of manufacture or installation dates, and so on.

The method 700 may include block 720. At block 720, the computing system identifies a first piece of pool or spa equipment of the plurality of pieces of pool or spa equipment corresponding to the first type of pool or spa equipment. The first piece of pool or spa equipment to update can be identified by querying the various tier two and tier three devices to identify a device to update. For example, identifying the device can involve querying a tier two device for information about connected tier three devices corresponding to the first type of pool or spa equipment. The tier device can then provide information about tier three devices including the first piece of pool or spa equipment that match the specified type. In this regard, the pool automation controller “sees through” the tier two device to identify the tier three devices that need to be updated. In some examples, all connected devices (e.g., all tier two devices and tier three devices together) may be queried together.

Querying devices may involve a structured request specifying a filter including the first type transmitted to the tier two device over a network interface. The query may be transmitted using a network protocol for IoT control, such as Zigbee or Z-Wave, as a unicast message addressed to the tier two device's network identifier. The tier two device may respond with a structured response enumerating tier three devices matching the specified equipment type.

The method 700 may include block 730. At block 730, the computing system downloads a firmware image for the first piece of pool or spa equipment. This block can proceed substantially as described with respect to block 320 of FIG. 3.

The method 700 may include block 740. At block 740, the computing system outputs a first instruction to the first piece of pool or spa equipment to update its firmware using the firmware image. This block can proceed substantially as described with respect to block 330 of FIG. 3. In some examples, the computing system can receive, from the first piece of pool or spa equipment, an indication of a status of the firmware update by the first piece of pool or spa equipment such as a success or failure message.

### Computing System

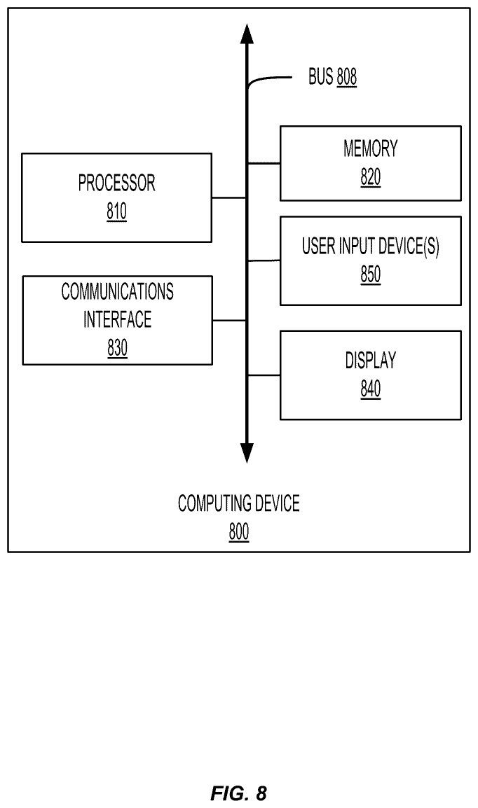

Referring now to FIG. 8, FIG. 8 shows an example computing device 800 suitable for use in example systems or methods for OTA firmware updates for multi-tiered pool and spa components by a pool automation controller. The example computing device 800 includes a processor 810 which is in communication with the memory 820 and other components of the computing device 800 using one or more communications buses 802. The processor 810 is configured to execute processor-executable instructions stored in the memory 820 to perform one or more methods for performing OTA firmware updates for multi-tiered pool and spa components by a pool automation controller, according to different examples, such as part or all of the example sequence diagram 200 or methods 300, 400, 500, 600, or 700 described above with respect to FIGS. 2-7. The computing device 800 also includes one or more user input devices 850, such as a keyboard, mouse, touchscreen, microphone, etc., to accept user input; however, in some examples, the computing device 800 may lack such user input devices, such as remote servers or cloud servers. The computing device 800 also includes a display 840 to provide visual output to a user.

The computing device 800 also includes a communications interface 830. In some examples, the communications interface 830 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random-access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

### General Considerations

The examples described herein are not intended to be mutually exclusive, exhaustive, or restrictive in any way, and the disclosure is not limited to these example embodiments but rather encompasses all possible modifications and variations within the scope of any claims ultimately drafted and issued in connection with the disclosure (and their equivalents). For avoidance of doubt, any combination of features not physically impossible or expressly identified as non-combinable herein may be within the scope of the disclosure. Further, although applicant has described devices and techniques for use principally with automated controllers, persons skilled in the relevant field will recognize that the present invention conceivably could be employed in connection with other objects and in other manners. Finally, references to “pools” and “swimming pools” herein may also refer to spas or other water containing vessels used for recreation, training, or therapy.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions, and changes in the form of the methods and systems described herein may be made without departing from the spirit of the present disclosure. The accompanying claims and their equivalents are intended to cover such forms or modifications as would fall within the scope and spirit of the present disclosure.

Although applicant has described devices and techniques for use principally with swimming pools and spas, persons skilled in the relevant field will recognize that the present invention may be employed in connection with other objects and in other manners. Finally, references to “pools” and “swimming pools” herein may also refer to spas or other water containing vessels used for recreation or therapy and for which cleaning is needed or desired.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

What is claimed is:

1. A method for updating firmware for pool and spa equipment included in a pool or spa system, comprising:
receiving, by a pool automation controller for the pool or spa system, a first indication of an available firmware update for a first piece of pool or spa equipment, wherein the first piece of pool or spa equipment is communicatively coupled with the pool automation controller;
downloading, by the pool automation controller, a firmware image; and
outputting, by the pool automation controller, a first instruction to the first piece of pool or spa equipment to update its firmware using the firmware image.

2. The method of claim 1, further comprising:
receiving, by the pool automation controller from the first piece of pool or spa equipment, a second indication of a status of the firmware update by the first piece of pool or spa equipment.

3. The method of claim 2, wherein:
the first piece of pool or spa equipment is further communicatively coupled with a controller device which is communicatively coupled with the pool automation controller;
the first instruction is sent via the controller device, wherein the first instruction is configured to cause the controller device to output a second instruction to the first piece of pool or spa equipment to update its firmware using the firmware image; and
the second indication is received from the controller device responsive to receiving a third indication of the status of the firmware update from the first piece of pool or spa equipment.

4. The method of claim 3, wherein:
the pool automation controller is a tier one device;
the controller device is a first tier two device of a plurality of tier two devices; and
the first piece of pool or spa equipment is a first tier three device of a plurality of tier three devices associated with the controller device.

5. The method of claim 4, wherein:
the first instruction is further configured to cause the controller device to update the firmware of the plurality of tier three devices associated with the controller device; and
the method further comprises receiving, by the pool automation controller from the controller device, fourth indications of statuses of the firmware update by the plurality of tier three devices.

6. The method of claim 1, wherein:
the method further comprises after downloading the firmware image, partitioning the firmware image; and
outputting the first instruction to the first piece of pool or spa equipment to update the firmware of the first piece of pool or spa equipment using the firmware image comprises streaming each partition of the firmware image sequentially to the first piece of pool or spa equipment.

7. The method of claim 1, wherein downloading the firmware image comprises:
responsive to receiving the first indication, accessing a remote update server based on information included in the first indication; and
receiving, from the remote update server, the firmware image.

8. The method of claim 1, wherein:
the first indication of the available firmware update for the first piece of pool or spa equipment is received from a remote task execution service; and
the first indication comprises information about the firmware image, an identification of the first piece of pool or spa equipment, and commands to download the firmware image and to update the firmware of the first piece of pool or spa equipment.

9. A pool or spa system comprising:
a tier one device; and
one or more tier two devices, wherein each tier two device is communicatively coupled with one or more tier three devices, wherein the tier three devices are pieces of pool or spa equipment controlled by a respective tier two device;
wherein in the tier one device comprises:
one or more non-transitory computer-readable media; and
one or more processors communicatively coupled to the one or more non-transitory computer-readable media, the one or more processors configured to execute processor-executable instructions stored in the non-transitory computer-readable media to:
download a firmware image;
output a first instruction to a first tier two device to update a firmware of one or more first tier three devices, wherein the first instruction is configured to cause the first tier two device to output a second instruction to one or more first tier three devices to update each tier three device's firmware; and
receive, from the first tier two device, a message including an indication of a completion status of the firmware update each of the one or more first tier three devices.

10. The pool or spa system of claim 9, wherein:
the pool or spa system further comprises one or more tier four devices, wherein each tier four device is communicatively coupled with a tier three device, wherein the tier four devices are subcomponents of the tier three devices; and
the first instruction is further configured to cause each of the one or more first tier three devices to update each tier four device's firmware.

11. The pool or spa system of claim 9, wherein:
the tier one device is a pool automation controller; and
the one or more tier two devices are controller devices.

12. The pool or spa system of claim 11, wherein:
the one or more tier two devices include a saltwater chlorinator controller; and
the one or more tier three devices associated with the saltwater chlorinator controller are salt cells.

13. The pool or spa system of claim 11, wherein:
the one or more tier two devices include a lighting controller; and
the one or more tier three devices associated with the lighting controller are lights.

14. The pool or spa system of claim 9, wherein:
the message including the indication of the completion status of the firmware update each of the one or more first tier three devices comprises as least one indication of a failed firmware update; and
the one or more processors are further configured to execute additional processor-executable instructions stored in the non-transitory computer-readable media to retry output of the first instruction to the first tier two device to update the firmware of the one or more first tier three devices, wherein the first instruction is further configured to cause the first tier two device to output a third instruction to a subset of the one or more tier three devices associated with the failed firmware update.

15. A pool automation controller for a pool or spa system comprising a plurality of pieces of pool or spa equipment, the pool automation controller comprising a non-transitory computer-readable storage medium storing processor-executable instructions configured to cause one or more processors to:
receive a first indication of an available firmware update for a first type of pool or spa equipment;
identify a first piece of pool or spa equipment of the plurality of pieces of pool or spa equipment corresponding to the first type of pool or spa equipment;
download a firmware image for the first piece of pool or spa equipment; and
output a first instruction to the first piece of pool or spa equipment to update its firmware using the firmware image.

16. The pool automation controller of claim 15, wherein the instructions are further configured to:
receive, from the first piece of pool or spa equipment, a second indication of a status of the firmware update by the first piece of pool or spa equipment.

17. The pool automation controller of claim 15, wherein the plurality of pieces of pool or spa equipment correspond to a hierarchical configuration controlled by the pool automation controller, the hierarchical configuration comprising:
the pool automation controller, a tier one device;
one or more tier two devices; and
one or more tier three devices wherein each tier three device is associated with at least one tier two device.

18. The pool automation controller of claim 17, wherein the instruction to identify the first piece of pool or spa equipment of the plurality of pieces of pool or spa equipment corresponding to the first type of pool or spa equipment comprises:
querying a first tier two device for information about connected tier three devices corresponding to the first type of pool or spa equipment; and
receiving information about one or more first tier three devices including the first piece of pool or spa equipment.

19. The pool automation controller of claim 17, wherein the instruction to identify the first piece of pool or spa equipment of the plurality of pieces of pool or spa equipment corresponding to the first type of pool or spa equipment comprises:
querying the one or more tier two devices or the one or more tier three devices for information about connected tier two or tier three devices corresponding to the first type of pool or spa equipment; and
receiving information about one or more first tier two or tier three devices including the first piece of pool or spa equipment.

20. The pool automation controller of claim 17, wherein:
the first instruction to the first piece of pool or spa equipment to update its firmware using the firmware image is provided to a first tier two device; and
the first instruction is configured to cause the first tier two device to output a second instruction to the first piece of pool or spa equipment to update its firmware using the firmware image.
